(19) United States
(12) Patent Application Publication
(10) Pub. No.: US 2013/0285498 A1
(43) Pub. Date: Oct. 31, 2013

(54) ROTOR OF BRUSHLESS DC MOTOR

(71) Applicant: SAMSUNG ELECTRO-MECHANICS CO., LTD., Suwon (KR)

(72) Inventors: Hae Jun Yang, Suwon (KR); Se Joo Kim, Suwon (KR); Ki Young Lee, Suwon (KR); Han Kyung Bae, Suwon (KR)

(73) Assignee: Samsung Electro-Mechanics Co., Ltd., Suwon (KR)

(21) Appl. No.: 13/870,562

(22) Filed: Apr. 25, 2013

(30) Foreign Application Priority Data
Apr. 26, 2012 (KR) 10-2012-0043849

(51) Int. Cl. H02K 1/27

(52) U.S. Cl. CPC H02K 1/27
USPC 310/156.12

(57) ABSTRACT

Disclosed herein is a rotor of a brushless direct current motor including magnets, a core in which the magnets are accommodated, a rotating shaft inserted into the core, and a pair of cover members inserted into the rotating shaft to cover both ends of the core, respectively.

### CROSS REFERENCE TO RELATED APPLICATION

This application claims the benefit of Korean Patent Application No. 10-2012-0043849, filed on Apr. 26, 2012, entitled “Rotor of Brushless DC Motor”, which is hereby incorporated by reference in its entirety into this application.

### BACKGROUND OF THE INVENTION

1. Technical Field

The present invention relates to a rotor of a brushless direct current (DC) motor.

2. Description of the Related Art

Generally, a rotor of a brushless DC motor in which a brush and a commutator are removed in a typical DC motor and are replaced with an electronic rectifier device, can reduce a mechanical or electrical noise thereof and also can be controlled to have various speeds from low speed to high speed. Therefore, the rotor of the brushless DC motor has been generally used as a driving unit of a compressor used in a refrigerating cycle of a refrigerator or an air conditioner.

The rotor of the brushless DC motor according to the prior art includes a stator provided at an outer side thereof, and a stator rotatably provided within the stator, wherein the inside of the stator is press-fitted with a rotating shaft, as described in Korean Patent Laid-Open Publication No. 20-2009-0002999.

Here, an inner surface of the stator is provided with a tooth which is extended to a central portion thereof and radially arranged, and a slot around which a coil is wound is formed between the adjacent teeth.

In addition, the rotor includes a rotor core provided to press-fit the rotating shaft into a central portion thereof and a plurality of permanent magnets arranged to have alternating polarity within the rotor core.

In the rotor of the brushless DC motor according to the prior art configured as described above, when a current application circuit applies current to the coil wound at each tooth of the stator according to a position of the rotor, each tooth sequentially has the alternating polarity of an N pole and an S pole. Therefore, magnetic force of attractive force and repulsive force generated by the magnetic force between the tooth of the stator and the permanent magnet of the rotor is applied in a tangential direction of the rotor to rotate the rotor.

However, performance of the rotor of the brushless DC motor according to the prior art may be deteriorated due to an effect of magnetic flux leakage. In addition, productivity may be deteriorated and a material cost may be increased due to complex production processes.

### PRIOR ART DOCUMENT

### Patent Document

(Patent Document 1) Korean Patent Laid-Open Publication No. 20-2009-0002999

### SUMMARY OF THE INVENTION

The present invention has been made in an effort to provide a rotor of a brushless DC motor capable of reducing an effect of magnetic flux leakage.

Further, the present invention has been made in an effort to provide a rotor of a brushless DC motor capable of reducing noise and vibration.

According to a preferred embodiment of the present invention, there is provided a rotor of a brushless direct current motor, including: a magnet; a core in which the magnet is accommodated; a rotating shaft inserted into the core; and a pair of cover members inserted into the rotating shaft to cover both ends of the core, respectively.

The core may be provided with fixing holes in a length direction of the rotating shaft, and fitting protrusions may be protruded from first portions of the cover members to be fitted into the fixing holes.

The fitting protrusions may be formed in a pillar shape.

The core may be formed of a separable core.

Fitting parts may be protruded from second portions of the cover members to fit between the core and the rotating shaft.

The fitting part may be extended in the length direction of the rotating shaft, and an coupling holes in which the rotating shaft is inserted is formed in a central portion of the fitting part.

Accommodating parts in which the magnets are accommodated may be formed on one portion of the core, wherein the accommodating part is formed larger than the magnet to form groove parts which are opened in a radial direction of the rotating shaft when accommodating the magnets, and the cover member may include a plurality of regulators which are formed at third portions of the cover member such that the regulators are coupled to the groove parts to prevent a separation of the magnet.

The regulator may be formed in a quadrangular pillar shape.

According to another preferred embodiment of the present invention, there is provided a rotor of the brushless direct current motor, including: a rotating shaft; a core having an insertion hole into which the rotating shaft is inserted formed on one portion thereof and a fixing hole formed on the other portion thereof in a length direction of the rotating shaft; magnets accommodated in the core; and injection molding products formed at both ends of the core and the fixing hole by an injection molding.

The injection molding product may include a fixing part formed by injecting an injection molding material between the core and the rotating shaft at the time of the injection molding.

The injection molding products may include coupling parts formed by injecting an injection molding material into the fixing hole at the time of the injection molding.

The injection molding product may be formed of an injection molding resin.

The core may be formed of a separable core.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing a rotor of a brushless direct current (DC) motor according to a preferred embodiment of the present invention;

FIG. 2 is a side cross-sectional view showing the rotor of the brushless DC motor according to a preferred embodiment of the present invention;

FIG. 3 is a rear view showing a cover member in the rotor of the brushless DC motor according to a preferred embodiment of the present invention;

FIG. 4 is a side cross-sectional view showing a cover member in the rotor of the brushless DC motor according to the preferred embodiment of the present invention;

FIG. 5 is a side cross-sectional view showing a rotor of a brushless DC motor according to another preferred embodiment of the present invention;

FIG. 6 is a lateral cross-sectional view showing the rotor of the brushless DC motor according to another preferred embodiment of the present invention;

FIG. 7 is a graph showing an output torque of the rotor of the brushless DC motor according to another preferred embodiment of the present invention;

FIG. 8 is an exploded perspective view showing the rotor of the brushless DC motor according to another preferred embodiment of the present invention; and

FIG. 9 is a lateral cross-sectional view showing the rotor of the brushless DC motor according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

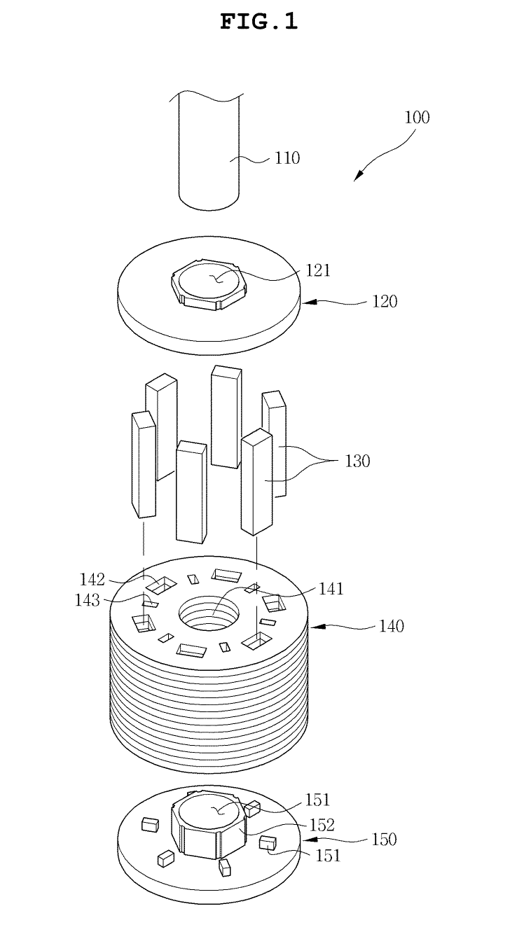

FIG. 1 is an exploded perspective view showing a rotor of a brushless direct current (DC) motor according to a preferred embodiment of the present invention. Referring to FIG. 1, a rotor 100 of a brushless DC motor according to a preferred embodiment of the present invention includes magnets 130, a core 140 in which the magnets 130 are accommodated, a rotating shaft 110 inserted into the core 140, and cover members 120 and 150 fixing the core 140 into the rotating shaft 110.

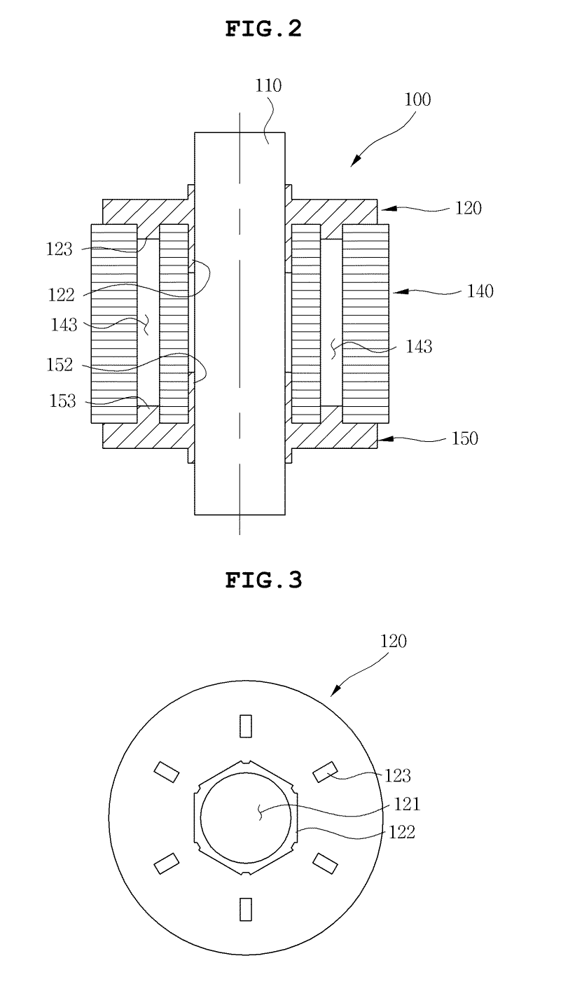

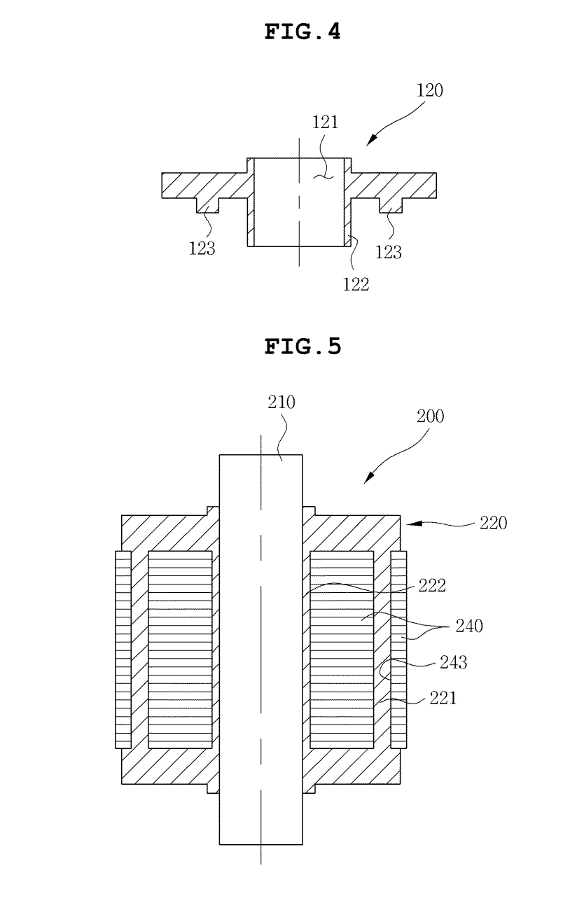

FIG. 2 is a side cross-sectional view showing the rotor of the brushless DC motor according to a preferred embodiment of the present invention. FIG. 3 is a rear view showing a cover member in the rotor of the brushless DC motor according to a preferred embodiment of the present invention. FIG. 4 is a side cross-sectional view showing the cover member in the rotor of the brushless DC motor according to a preferred embodiment of the present invention.

Hereinafter, the rotor 100 of the brushless DC motor according to the preferred embodiment of the present invention will be described in more detail with reference to FIGS. 1 to 4.

Firstly, referring to FIG. 1, the magnets 130 are configured of a permanent magnet to generate a magnetic field. Here, the magnet 130 may be formed in a rectangular shape and be formed in plural. However, the shape of the magnet 130 according to the preferred embodiment of the present invention is not limited thereto.

Referring to FIGS. 1 and 2, a plurality of accommodating parts 142 accommodating the plurality of magnets 130 are formed on one portion of the core 140. In addition, fixing holes 143 are formed on the other portion of the core 140 in a length direction of the rotating shaft 110. Here, the fixing hole 143 may have a circular or quadrangular shape, but the shape of the fixing hole 143 according to the preferred embodiment of the present invention is not limited thereto.

In addition, an insertion hole 141 is formed in a central portion of the core 140 in the length direction of the rotating shaft 110. Here, the insertion hole 141 may be formed to correspond to an outer peripheral surface of the rotating shaft 110.

In addition, the core 140 may be formed of a separable core 140 that is configured of a plurality of core plates (not shown).

The rotating shaft 110 has a cylindrical shape and is inserted into the insertion hole 141 of the core 140. However, the rotating shaft 110 according to the preferred embodiment of the present invention is not limited to the cylindrical shape.

Referring to FIGS. 1 to 4, the cover members 120 and 150 are disposed at both ends of top and bottom of the core 140 to cover both ends of the core 140. In addition, coupling holes 121 and 151 which are coupled to the rotating shaft 110 are formed at central portions of the cover members 120 and 150.

In addition, fitting parts 122 and 152 may be protruded from one portion of the cover members 120 and 150 to fit between the core 140 and the rotating shaft 110. As a result, the core 140 may be fixed to the rotating shaft 110.

Here, the rotating shaft 110 may have a smaller diameter than that of the coupling holes 121 and 151 of the cover members 120 and 150. Therefore, the outer peripheral surface of the rotating shaft 110 and inner peripheral surfaces of the coupling holes 121 and 151 may be spaced apart from each other at a predetermined distance. Here, the fitting parts 122 and 152 may have a thickness equal to or greater than the distance between the outer peripheral surface of the rotating shaft 110 and the inner peripheral surface of the coupling holes 121 and 151.

In addition, fitting protrusions 123 and 153 may be protruded from the other portion of the cover members 120 and 150 to fit into the fixing holes 143. Here, the fitting protrusions 123 and 153 may have a shape corresponding to the shape of the fixing hole 143, and may have a size equal to or greater than that of the fixing hole 143.

In addition, the plurality of fitting protrusions 123 and 153 may be formed in a pillar shape. Here, lateral cross sections of the fitting protrusions 123 and 153 may have a circular or quadrangular shape, but the preferred embodiment of the present invention is not limited thereto.

Therefore, the plurality of cover members 120 and 150 are disposed on both ends of the top and bottom of the core 140 and the fitting protrusions 123 and 153 of the cover members 120 and 150 are fitted into both ends of the top and the bottom of the fixing holes 143 of the core 140. As a result, the core 140 may be easily fixed to the rotating shaft 110. Here, even when the core 140 is formed of a separable core, the separable core may be easily fixed to each other by the plurality of cover members 120 and 150.

In the rotor 100 of the brushless DC motor according to the preferred embodiment of the present invention as described above, the core 140 may be fixed to each other by using the cover members 120 and 150 instead of a pin, a stopper pin and a bearing ring used in order to fix a separable core according to the prior art, thereby reducing the noise and vibration of the rotor.

In addition, in the rotor 100 of the brushless DC motor according to the preferred embodiment of the present invention, the cover members 120 and 150 cover the accommodating parts 142 in which the magnets 130 are accommodated, thereby reducing the magnetic flux leakage.

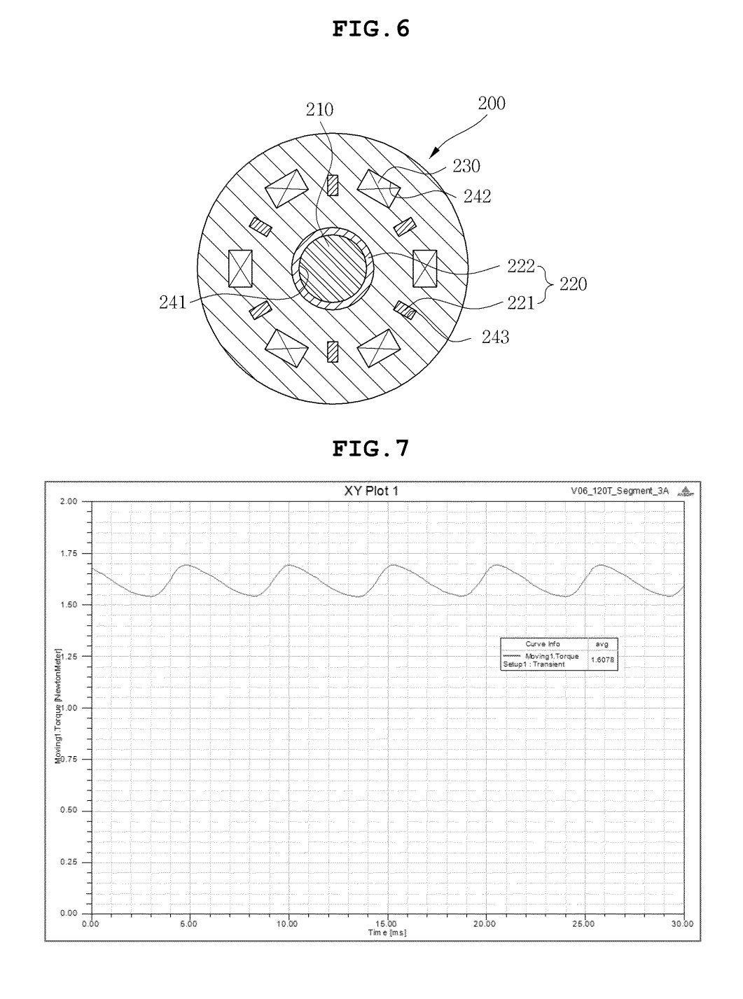

FIG. 5 is a side cross-sectional view showing a rotor of a brushless DC motor according to another preferred embodiment of the present invention. FIG. 6 is a lateral cross-sectional view showing the rotor of the brushless DC motor according to another preferred embodiment of the present invention.

Referring to FIGS. 5 and 6, a rotor 200 of a brushless DC motor according to another preferred embodiment of the present invention includes a rotating shaft 210, a core 240, magnets 230 and injection molding products 220.

Hereinafter, the rotor 200 of the brushless DC motor according to another preferred embodiment of the present invention will be described in more detail with reference to FIGS. 5 and 6.

Firstly, referring to FIGS. 5 and 6, the magnet 230 is configured of a permanent magnet to generate a magnetic field. Here, the magnet 230 may be formed in a rectangular shape and may be formed in plural. However, shape and material of the magnet 230 according to the preferred embodiment of the present invention are not limited thereto.

A plurality of accommodating parts 242 accommodating a plurality of magnets 230 are formed on one portion of the core 240. In addition, fixing holes 243 are formed on the other portion of the core 240 in a length direction of the rotating shaft 210. Here, the fixing hole 243 may have a circular or quadrangular shape, but the shape of the fixing hole 243 according to the preferred embodiment of the present invention is not limited thereto.

In addition, an insertion hole 241 is formed in a central portion of the core 240 in the length direction of the rotating shaft 210. In this configuration, the insertion hole 241 may be formed to correspond to an outer peripheral surface of the rotating shaft 210.

In addition, the core 240 may be formed of a separable core 240 that is configured of a plurality of core plates (not shown).

The rotating shaft 210 is formed in a cylindrical shape and is inserted into the insertion hole 241 of the core 240. However, the rotating shaft 210 according to the preferred embodiment of the present invention is not limited to the cylindrical shape.

The injection molding product 220 are formed by an injection molding, and are disposed at both ends of top and bottom of the core 240 to cover both ends of the core 240. Here, the injection molding product 220 may be formed of an injection molding resin. Here, the injection molding resin may be for example, polyvinyl chloride or polypropylene, but a material of the injection molding resin according to the preferred embodiment of the present invention is not limited thereto.

In addition, the injection molding product 220 includes a fixing part 222 formed by injecting an injection molding material between the core 240 and the rotating shaft 210. Here, the fixing part 222 may fix the core 240 and the rotating shaft 210 to each other.

In addition, the rotating shaft 210 may have a smaller diameter than that of the insertion hole 241 of the core 240. Therefore, an outer peripheral surface of the rotating shaft 210 and an inner peripheral surface of the insertion hole 241 may be spaced apart from each other at a predetermined distance.

In addition, the injection molding material is entirely injected into a gap between the rotating shaft 210 and the insertion hole 241 of the core 240, thereby forming the fixing part 222. Here, the fixing part 222 may have a cylindrical shape.

In addition, the injection molding product 220 may further include a coupling part 221 formed by injecting the injecting molding material into the fixing hole 243 of the core 240 at the time of forming the injection molding products 220 at both ends of the core 240 by an injection molding process.

Here, the coupling part 221 may be formed in a pillar shape connecting the injection molding products 220 formed at both ends of the core. Here, the coupling part 221 may be formed in a cylindrical shape or a quadrangular pillar shape, but the preferred embodiment of the present invention is not limited thereto.

Therefore, the plurality of injection molding products 220 are disposed on both ends of the top and bottom of the core 240 and the coupling part 221 of the injection molding products 220 connects both ends of top and bottom of the injection molding products 220 to each other. As a result, when the core 240 is formed in a separated shape, the core having the separated shape may be easily fixed to each other.

In the rotor 200 of the brushless DC motor according to another preferred embodiment of the present invention as described above, a separable core 240 may be fixed to each other by using the injection molding product 220 instead of a pin, a stopper pin and a bearing ring used in order to fix the separable core 240 according to the prior art, thereby reducing the noise and vibration of the rotor.

In addition, in the rotor 200 of the brushless DC motor according to another preferred embodiment of the present invention, both ends of the injection molding product 220 formed on the top and bottom ends of the core 240, the fixing part 222 and the coupling part 221 are integrally formed. As a result, an operation of fixing the core 240 may be facilitated and a manufacturing time of the rotor 200 of the brushless DC motor may be shortened.

In addition, in the rotor 200 of the brushless DC motor according to another preferred embodiment of the present invention, the injection molding products 220 cover accommodating parts 242 in which the magnets 230 are accommodated, thereby reducing the magnetic flux leakage.

FIG. 7 is a graph showing an output torque of the rotor 200 of the brushless DC motor according to another preferred embodiment of the present invention. As shown in FIG. 7, it can be appreciated that the rotor 200 of the brushless DC motor according to the preferred embodiment of the present invention generates a torque of 1.5 to 17.5 Nm when the rotor is applied with a current of 5 A, which is higher by about 40 percentage as compared to the torque of 1.0 to 1.25 Nm according to the prior art.

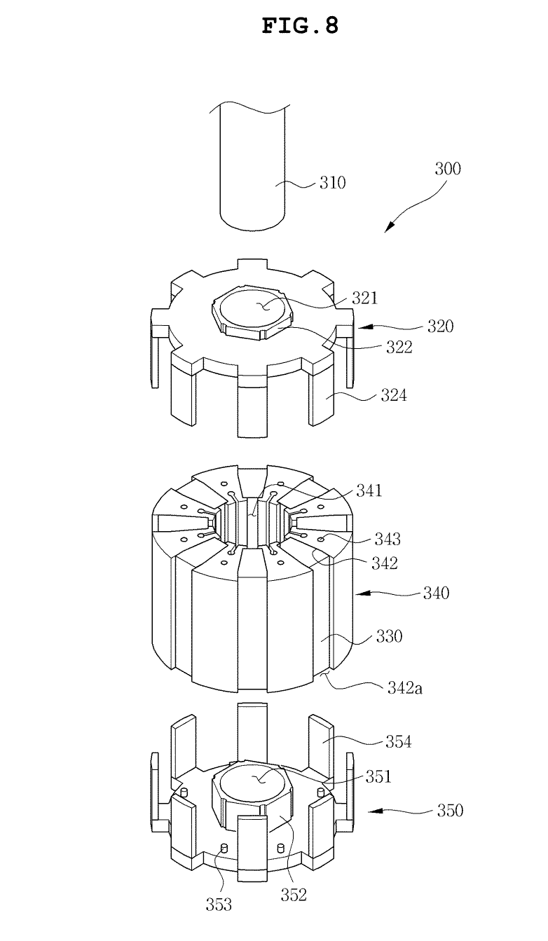

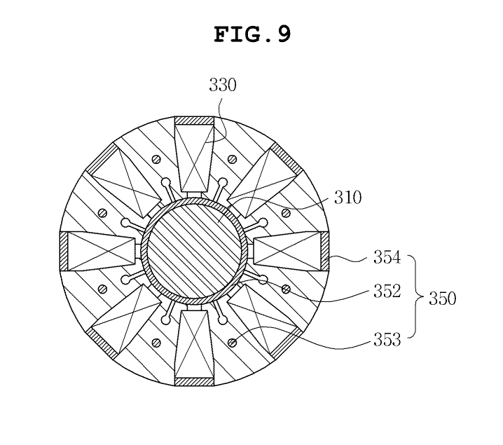

FIG. 8 is an exploded perspective view showing the rotor of the brushless DC motor according to another preferred embodiment of the present invention. FIG. 9 is a lateral cross-sectional view showing the rotor of the brushless DC motor according to another preferred embodiment of the present invention.

Referring to FIG. 8, a rotor 300 of a brushless DC motor according to a preferred embodiment of the present invention includes magnets 330, a core 340 in which the magnets 330 are accommodated, a rotating shaft 310 inserted into the core 340, and cover members 320 and 350 fixing the core 340 into the rotating shaft 310.

Hereinafter, the rotor 300 of the brushless DC motor according to another preferred embodiment of the present invention will be described in more detail with reference to FIGS. 8 and 9.

Firstly, referring to FIG. 8, the magnets 330 are accommodated in the core 340 and are configured of permanent magnets to generate a magnetic field. Here, the magnet 330 may be formed in a rectangular shape and may be formed in plural. However, the shape of the magnet 330 according to the preferred embodiment of the present invention is not limited thereto.

Referring to FIGS. 8 and 9, a plurality of accommodating parts 342 accommodating a plurality of magnets 330 are formed on one portion of the core 340. Here, one portion of the accommodating part 342 is opened in a radial direction. Here, the accommodating part 342 may have a size larger than a size of the magnet 330 to form a groove part 342a opened in the radial direction of the rotating shaft 310 at the time of accommodating the magnet 330 in the accommodating part 342. In addition, the core 340 may be formed of a separable core that is configured of a plurality core plates. However, the preferred embodiment of the present invention is not limited thereto.

In addition, fixing holes 343 are formed on the other portion of the core 340 in a length direction of the rotating shaft 310. Here, the fixing hole 343 may have a circular or quadrangular shape, but the shape of the fixing hole 343 according to the preferred embodiment of the present invention is not limited thereto.

In addition, an insertion hole 341 is formed in a central portion of the core 340 in the length direction of the rotating shaft 310. Here, the insertion hole 341 may be formed to correspond to an outer peripheral surface of the rotating shaft 310.

In addition, the core 340 may be formed of a separable core 340 that is configured of a plurality of core plates (not shown).

The rotating shaft 310 is formed in a cylindrical shape and is inserted into the insertion hole 341 of the core 340. However, the shape of the rotating shaft 310 according to the preferred embodiment of the present invention is not limited to the cylindrical shape.

Referring to FIGS. 8 and 9, the cover members 320 and 350 are disposed at both ends of top and bottom of the core 340 to cover both ends of the core 340. In addition, coupling holes 321 and 351 which are coupled to the rotating shaft 310 are formed in a central portion of the cover members 320 and 350.

In addition, a plurality of regulators 354 are formed on portions of the cover members 320 and 350, and the regulators 354 are coupled to the groove parts 342a formed when the magnet 330 is accommodated in the accommodating part 342 of the core 340.

Here, when the plurality of cover members 320 and 350 are coupled to both sides of top and bottom of the core 340, the regulators 354 of the cover members 320 and 350 close the groove parts 342a which are opened in the radial direction of the rotating shaft 310, which may prevent the magnets 330 from separating toward an outside of the core 340.

Here, one portion of the regulator 354 may be formed to correspond to the groove part 342a such that the regulator 354 may be inserted into the groove part 342a.

In addition, the regulator 354 may be formed in a rectangular pillar shape and may be extended in the length direction of the rotating shaft 3101. However, the shape of the regulator 354 according to another preferred embodiment of the present invention is not necessarily limited thereto.

In addition, fitting parts 322 and 352 may be protruded from the cover members 320 and 350 along an edge of the coupling holes to fit between the core 340 and the rotating shaft 310. As a result, the core 340 may be fixed to the rotating shaft 310.

Here, the rotating shaft 310 may have a smaller diameter than that of the coupling holes 321 and 351 of the cover members 320 and 350. Therefore, an outer peripheral surface of the rotating shaft 310 and an inner peripheral surface of the coupling holes 321 and 351 may be spaced apart from each other at a predetermined distance. Here, the fitting portion 352 may have a thickness equal to or greater than the distance between the outer peripheral surface of the rotating shaft 310 and the inner peripheral surface of the coupling holes 321 and 351.

In addition, the plurality of fitting protrusions 353 may be protruded from the other portion of the cover members 320 and 350 to fit into the fixing hole 343 of the core 340. Here, the fitting protrusions 353 may have a shape corresponding to the shape of the fixing hole 343, and may have a size equal to or greater than that of the fixing hole 343.

In addition, the plurality of fitting protrusions 353 may be formed in a pillar shape. Here, lateral cross section of the fitting protrusions 353 may have a circular or quadrangular shape, but the preferred embodiment of the present invention is not limited thereto.

Therefore, the plurality of cover members 320 and 350 are disposed on both ends of top and bottom of the core 340 and the fitting protrusions 353 of the cover members 320 and 350 are fitted into both ends of the top and the bottom of the fixing holes 343 of the core 340. As a result, the core 340 may be fixed to the rotating shaft 310. Here, even when the core 340 may be formed of the separable core which is formed in a separated shape, the separable core may be easily fixed to each other by the plurality of cover members 320 and 350.

In the rotor 300 of the brushless DC motor according to another preferred embodiment of the present invention as described above, the core 340 may be fixed to each other by using the cover members 320 and 350 instead of a pin, a stopper pin and a bearing ring used in order to fix a separable core 340 according to the prior art, thereby reducing the noise and vibration of the rotor.

In addition, in the rotor 300 of the brushless DC motor according to another preferred embodiment of the present invention, the cover members 320 and 350 cover accommodating grooves 344 in which the magnets 330 are accommodated, thereby reducing the magnetic flux leakage.

In addition, in the rotor 300 of the brushless DC motor according to another preferred embodiment of the present invention, regulators 354 are formed in the cover members 320 and 350, which may prevent the magnets 300 which are accommodated in the core 340 from separating in the radial direction of the rotating shaft 310.

The preferred embodiments of the present invention can reduce the effect of magnetic flux leakage of the rotor of the brushless DC motor, thereby improving a performance thereof.

The preferred embodiments of the present invention can integrally cover a core, thereby reducing the noise and vibration.

In addition, the preferred embodiments of the present invention can simplify the structure of the rotor of the brushless DC motor, simplify production process, increase productivity, and reduce material cost.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A rotor of a brushless direct current motor, comprising:
a magnet;
a core in which the magnet is accommodated;
a rotating shaft inserted into the core; and
a pair of cover members inserted into the rotating shaft to cover both ends of the core, respectively.

2. The rotor of the brushless direct current motor as set forth in claim 1, wherein the core is provided with fixing holes in a length direction of the rotating shaft, and
fitting protrusions are protruded from first portions of the cover members to be fitted into the fixing holes.

3. The rotor of the brushless direct current motor as set forth in claim 2, wherein the fitting protrusions are formed in a pillar shape.

4. The rotor of the brushless direct current motor as set forth in claim 1, wherein the core is formed of a separable core.

5. The rotor of the brushless direct current motor as set forth in claim 1, wherein fitting parts are protruded from second portions of the cover members to fit between the core and the rotating shaft.

6. The rotor of the brushless direct current motor as set forth in claim 5, wherein the fitting part is extended in the length direction of the rotating shaft, and an coupling holes in which the rotating shaft is inserted is formed in a central portion of the fitting part.

7. The rotor of the brushless direct current motor as set forth in claim 1, wherein accommodating parts in which the magnets are accommodated are formed on one portion of the core, the accommodating part being formed larger than the magnet to form groove parts which are opened in a radial direction of the rotating shaft when accommodating the magnets, and
the cover member includes a plurality of regulators which are formed at third portions of the cover member such that the regulators are coupled to the groove parts to prevent a separation of the magnet.

8. The rotor of the brushless direct current motor as set forth in claim 7, wherein the regulator is formed in a quadrangular pillar shape.

9. A rotor of the brushless direct current motor, comprising:
a rotating shaft;
a core having an insertion hole into which the rotating shaft is inserted formed on one portion thereof and a fixing hole formed on the other portion thereof in a length direction of the rotating shaft;
magnets accommodated in the core; and
injection molding products formed at both ends of the core and the fixing hole by an injection molding.

10. The rotor of the brushless direct current motor as set forth in claim 9, wherein the injection molding product includes a fixing part formed by injecting an injection molding material between the core and the rotating shaft at the time of the injection molding.

11. The rotor of the brushless direct current motor as set forth in claim 9, wherein the injection molding products include coupling parts formed by injecting an injection molding material into the fixing hole at the time of the injection molding.

12. The rotor of the brushless direct current motor as set forth in claim 9, wherein the injection molding product is formed of an injection molding resin.

13. The rotor of the brushless direct current motor as set forth in claim 9, wherein the core is formed of a separable core.
